(19) United States
(12) Patent Application Publication
(10) Pub. No.: US 2009/0197133 A1
(43) Pub. Date: Aug. 6, 2009

(54) METHOD FOR PRODUCING FUEL CELL ELECTRODES AND POLYMER ELECTROLYTE FUEL CELLS HAVING FUEL CELL ELECTRODES

(76) Inventor: Hiroshi Hamaguchi, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/090,258

(22) PCT Filed: Dec. 7, 2006
(86) PCT No.: PCT/JP2006/324892

§ 371 Date: Apr. 15, 2008

(30) Foreign Application Priority Data
Dec. 9, 2005 (JP) 2005-356198

(51) Int. Cl. H01M 8/10; H01M 4/88

(52) U.S. Cl. 429/30; 502/101

(57) ABSTRACT

It is an objective of the present invention to secure the sufficient presence of a three-phase interface on a carbon carrier, where reaction gas, catalysts, and electrolytes meet so as to improve efficiency of catalysts used. A method for producing a fuel cell electrode is provided, such method comprising the steps of: allowing a carbon carrier having pores to support a catalyst; introducing a functional group serving as a polymerization initiator onto the surface and/or into the pores of the carbon carrier having pores; introducing monomer electrolytes or monomer electrolyte precursors so as to polymerize the monomer electrolytes or the monomer electrolyte precursors using the polymerization initiator as an initiation point; allowing polymers on the catalyst-supporting carrier to be protonated; dehydrating protonated products and dispersing them in water; allowing the dispersion products to be subjected to filter treatment; and preparing a catalyst paste using the obtained catalyst powders and forming the catalyst paste into a given form so as to produce a catalyst layer; and characterized in that perfluorocarbon polymers having sulfonic acid groups are mixed with the catalyst paste when a catalyst layer is produced using the obtained catalyst powder.

### TECHNICAL FIELD

The present invention relates to a method for producing a fuel cell electrode and a polymer electrolyte fuel cell having a fuel cell electrode.

### BACKGROUND ART

Polymer electrolyte fuel cells having a polymer electrolyte membrane can be easily reduced in size and weight. For this reason, there are growing expectations for the practical application thereof as a power source for moving vehicles, such as electric vehicles, and for small-sized cogeneration systems.

Electrode reactions within the catalyst layers of the anode and cathode of a polymer electrolyte fuel cell proceed at a three-phase interface (to be hereafter referred to as a reaction site) where reaction gas, catalysts, and a fluorine-containing ion exchange resin (electrolyte) exist simultaneously. Accordingly, in the polymer electrolyte fuel cells, the catalyst layers are conventionally made of catalysts (such as metal-supporting carbon, for example, consisting of a carbon black carrier with a large specific surface area by which a metal catalyst, such as platinum, is supported) that are coated with the same or a different kind of fluorine-containing ion exchange resin as that of the polymer electrolyte membrane.

As described above, generation of protons and electrons takes place at the anode with the coexistence of three phases comprising catalysts, carbon particles, and electrolytes, respectively. That is, electrolytes that conduct protons and carbon particles that conduct electrons coexist, and hydrogen gas is reduced due to the presence of a catalyst. Thus, as a carbon particle supports a larger amount of a catalyst, higher efficiency of power generation can be obtained. The same can be applied to the case of the cathode. However, catalysts used in a fuel cell are precious metals such as platinum. Thus, when the amount of a catalyst supported on a carbon particle increases, fuel cell production cost also increases, which is problematic.

In accordance with conventional methods for producing a catalyst layer, electrolytes such as Nafion (trade name) and catalyst powders of platinum/carbon or the like are dispersed in a solvent, and the thus obtained ink is cast, followed by dehydration. The obtained catalyst powders often have pores several to several tens of nanometers in size. Thus, electrolytes that are polymers having large molecular sizes cannot enter such nano-order size pores. In such case, it is assumed that electrolytes merely cover the surface of the catalyst. Accordingly, platinum cannot be effectively used when it is located in a pore, causing deterioration of catalyst performance.

JP Patent Publication (Kokai) No. 2002-373662 A discloses a method for producing a fuel cell electrode, which is intended to improve power generation efficiency without increasing the amount of a catalyst that is supported on a carbon particle. In accordance with this method, an electrode paste obtained by mixing particles having catalyst particles supported on the surfaces thereof with ion-conducting polymers is treated with a solution containing catalytic metal ions, the catalytic metal ions are used for ion exchange on the ion-conducting polymers, and the catalytic metal ion is reduced.

Also, JP Patent Publication (Kokai) No. 6-271687 A (1994) discloses a method for producing an ion exchange membrane, which is intended to produce an ion exchange membrane having sufficient thermostability and chemical resistance but not having defects. In accordance with the method, a substrate comprising fluorine polymers is immersed in polymerizable monomers such that the monomers are supported on the polymers, the polymerizable monomers partially undergo reaction via irradiation with ionizing radiation in a first step, unreacted monomers are polymerized by heating in the presence of a polymerization initiator in a second step, and ion exchange groups are introduced thereinto according to need. In terms of exposure dose, the dose in the first step is determined to be a specific dose.

### DISCLOSURE OF THE INVENTION

However, even when the treatment described in Patent Document 1 is carried out, there is a limitation to the possible improvement of power generation efficiency. This is because a catalyst-supporting carbon particle has nano-order size pores that macromolecules such as polymers cannot enter so that a catalyst such as platinum adsorbed to such pores cannot serve at the aforementioned three-phase interface (the reaction site). As described above, polymer electrolytes have been unable to enter carbon pores, which has been problematic.

In addition, the method disclosed in Patent Document 2 relates to a method for producing an ion exchange membrane. When carrying out the method, it is not easy to conduct operations for irradiation, for example.

The present invention has been made in view of the foregoing problems of the prior art. It is an objective of the present invention to secure the sufficient presence of a three-phase interface on a carbon carrier, where reaction gas, catalysts, and electrolytes meet so as to improve catalyst efficiency. Accordingly, an electrode reaction proceeds with efficiency so that fuel cell power generation efficiency can be improved. Further, it is another objective of the present invention to provide an electrode having excellent properties and a polymer electrolyte fuel cell comprising such electrode that is capable of producing high battery output. In addition, the use of the present invention is not limited to a polymer electrolyte fuel cell, and thus the present invention can be applied to various types of catalysts used with carbon carriers.

The inventors of the present invention have found that the above objectives can be achieved with the use of a catalyst paste in which catalyst powders obtained by preparing carbon carriers each having nano-order size pores in which polymer electrolytes have been produced in situ are mixed with perfluorocarbon polymers such as Nafion (trade name) having sulfonic acid groups. This has led to the completion of the present invention.

That is, in a first aspect, the present invention relates to a method for producing a fuel cell electrode, comprising the steps of: (1) allowing a carbon carrier having pores to support a catalyst; (2) introducing a functional group serving as a polymerization initiator onto the surface and/or into the pores of a carbon carrier having pores; (3) introducing monomer electrolytes or monomer electrolyte precursors so as to polymerize the monomer electrolytes or the monomer electrolyte precursors using the polymerization initiator as an initiation point; (4) allowing polymers on the catalyst-supporting carrier to be protonated; (5) dehydrating protonated products and dispersing them in water; (6) allowing the dispersion products to be subjected to filter treatment; and (7) preparing a catalyst paste using the obtained catalyst powders and forming the catalyst paste into a given form so as to produce a catalyst layer; and characterized in that perfluorocarbon polymers having sulfonic acid groups are mixed with the catalyst paste when a catalyst layer is produced using the catalyst powder obtained in (6) above.

In accordance with the method for producing a fuel cell electrode comprising catalyst-supporting carbon particles and polymer electrolytes of the present invention, a polymer electrolyte and a catalyst are allowed to exist on the surface of a carbon carrier having pores and in the nano-level-sized pores of the carbon carrier. In addition, a layer comprising perfluorocarbon polymers having sulfonic acid groups is produced mainly on the surface of a carbon carrier. Accordingly, conductivity between carbon carriers can be improved.

Thus, with the use of the fuel cell electrode obtained by the present invention, a catalyst utilization ratio can be improved. Therefore, in a fuel cell electrode comprising ion exchange resin, carbon particles, and a catalyst, a three-phase interface is formed with the use of a catalyst in the bottom of a nanopore of a carbon carrier so that the existing catalyst can be effectively used for reaction. As described above, monomer electrolytes and catalyst-supporting carriers are mixed together so that the monomers are polymerized. Thus, ion exchange paths are formed in the pores of such carriers, resulting in improved catalyst utilization ratio. Accordingly, power generation efficiency can be improved while using the same amount of materials.

In the case of the fuel cell electrode that is produced in accordance with the present invention, the effective utilization ratio of precious metals such as platinum that are supported on carriers is improved, and the power generation efficiency is also improved, compared with a fuel cell electrode obtained without mixing perfluorocarbon polymers having sulfonic acid groups with a catalyst paste.

In accordance with the present invention, the effective utilization ratio of the catalyst is improved as the amount of perfluorocarbon polymers (which have sulfonic acid groups) mixed increases. In order to secure excellent power generation efficiency, the amount of perfluorocarbon polymers (which have sulfonic acid groups) mixed accounts for preferably 5% to 70% and more preferably 10% to 60% of the weight of carbon carriers.

Preferably, living polymerization is carried out such that the molecular weight of a monomer electrolyte or a monomer electrolyte precursor falls within the optimum range after polymerization. Therefore, preferably, the polymerization initiator is a living radical polymerization initiator or a living anion polymerization initiator. Such living radical polymerization initiator is not particularly limited. A preferred example thereof is 2-bromoisobutyric acid bromide.

An example of a monomer electrolyte that can be used is an unsaturated compound comprising sulfonic acid groups, phosphoric acid groups, carboxylic acid groups, and ammonium groups, but examples are not particularly limited thereto. In addition, examples of monomer electrolyte precursors that can be used include, but are not particularly limited to, an unsaturated compound from which sulfonic acid groups, phosphoric acid groups, carboxylic acid groups, and ammonium groups can be generated via hydrolysis and the like after polymerization and an unsaturated compound into which sulfonic acid groups, phosphoric acid groups, carboxylic acid groups, and ammonium groups can be introduced after polymerization. Among them, a preferred example is styrenesulfonic acid ethyl.

In a second aspect, the invention relates to a polymer electrolyte fuel cell comprising an anode, a cathode, and a polymer electrolyte membrane disposed between the anode and the cathode, comprising the above-described fuel cell electrode as the anode and/or cathode.

As described above, when the aforementioned electrode of the present invention having high catalyst efficiency and excellent electrode properties is provided, a polymer electrolyte fuel cell having high battery output can be structured. In addition, the electrode of the present invention has high catalyst efficiency and excellent durability. Thus, high battery output can be stably obtained for a long period of time when using a polymer electrolyte fuel cell of the present invention comprising such electrode.

In accordance with the present invention, polymer electrolytes can be uniformly synthesized (produced) on the surface and in pores of a catalyst-supporting carbon carrier. Thus, the amount of an inactive catalyst that does not come into contact with such electrolytes can be reduced. In addition, a layer comprising perfluorocarbon polymers having sulfonic acid groups is provided mainly on the surface of a carbon carrier so that conductivity between such carbon carriers can be improved.

### BRIEF DESCRIPTION OF THE DRAWINGS

FIG. 1 shows a schematic view of a conventional catalyst-supporting carrier.

FIG. 2 shows a schematic view of a catalyst-supporting carrier of the prior art of the present invention, which comprises a catalyst-supporting carbon particle and polymer electrolytes.

FIG. 3 shows a schematic view of a catalyst-supporting carrier of the present invention, which comprises a catalyst-supporting carbon particle, polymer electrolytes that have been polymerized in situ, and polymer electrolytes mixed with a catalyst paste.

FIG. 4 shows reaction schemes of the Examples of the present invention.

FIG. 5 shows voltages upon power generation of 1 A/cm² obtained based on a current density-voltage curve during fuel cell power generation experiments.

### BEST MODE FOR CARRYING OUT THE INVENTION

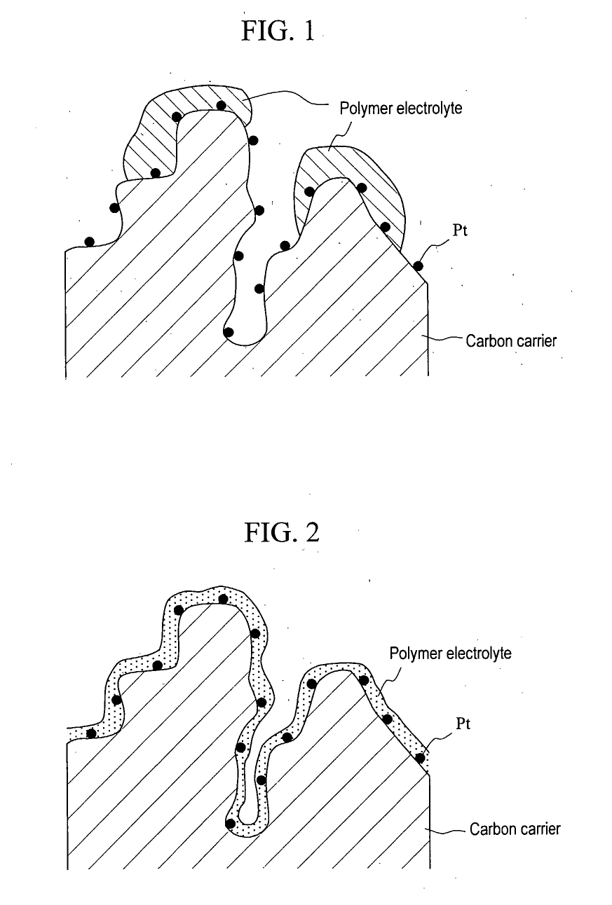

Hereafter, the present invention is described with reference to the drawings. FIGS. 1-3 show schematic views of conventional catalyst-supporting carriers and a catalyst-supporting carrier of the present invention.

FIG. 1 shows a conventional catalyst-supporting carrier obtained by sufficiently dispersing catalyst-supporting carbon particles and a polymer electrolyte solution such as a solution containing Nafion (trade name) in an adequate solvent and forming the resultant into a thin film, followed by dehydration. As shown in the figure, a catalyst exists in the bottom of a pore; however, only some parts of the surface of the carbon carrier are coated with polymer electrolytes. Since some parts of the catalyst-supporting carrier are thickly coated, the sufficient presence of a three-phase interface where reaction gas, catalysts, and electrolytes meet cannot be realized. Thus, the catalyst efficiency cannot be improved.

In accordance with the above conventional method, Nafion in the form of polymers is dispersed with catalyst-supporting carbon particles. Meanwhile, the catalyst-supporting carbon carrier has a significantly large specific surface area (approximately 1000 m²/g). In addition, very small catalyst particles with pore sizes of 2 to 3 nm, each of which consists of several molecules, are carried in nanopores of the carbon carrier. Thus, there are few pores available for accommodating molecules such as a polymer electrolyte having a molecular weight of thousands to tens of thousands. Therefore, a major part of the catalyst in the bottom of a pore of the carbon carrier does not come into contact with electrolytes so that such catalyst cannot contribute to a reaction. Hitherto, the utilization ratio of a catalyst supported on a carbon carrier has been believed to be around 10%. In the case of a system in which expensive platinum or the like is used as a catalyst, it has been a longstanding objective to improve the utilization ratio thereof.

FIG. 2 shows a catalyst-supporting carrier of the prior art of the present invention, which comprises a carbon particle by which a catalyst, such as platinum is supported and polymer electrolytes. As shown in the figure, a catalyst exists on the surface and/or in a pore of a carbon carrier. In addition, polymer electrolytes are uniformly and thinly distributed on the surface and in a pore of a carbon carrier. Accordingly, the sufficient presence of a three-phase interface where reaction gas, catalysts, and electrolytes meet can be secured with the carbon carrier, resulting in improved catalyst efficiency.

The fuel cell electrode of the prior art is produced in a manner such that a polymerization initiator is introduced on the outer surface of a carbon carrier, monomer electrolytes that constitute a polymer electrolyte are mixed therewith, and polymerization takes place, so that polymer electrolytes are uniformly and thinly formed on the surface and/or in a nanopore of a carbon carrier. At such time, monomers that can serve as electrolytes are fixed on the surface of carbon. In addition, such monomers have molecular weights of several tens to several hundreds so that they can be delivered to the bottoms of nanopores. Thus, it becomes possible to use a catalyst that is located in the bottom of a pore and is not in contact with electrolytes when polymerization takes place in such pore. Therefore, high performance can be achieved with the use of a small amount of a catalyst.

As described above, the fuel cell electrode of the prior art is effective in terms of efficiency of catalysts used. However, in accordance with the present invention, the catalyst efficiency is further improved.

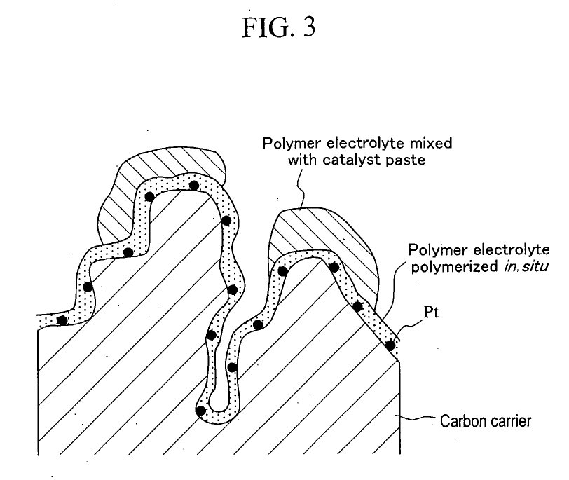

FIG. 3 shows a catalyst-supporting carrier used for the fuel cell electrode catalyst of the present invention, which comprises a carbon particle by which a catalyst such as platinum is supported, polymer electrolytes that have been polymerized in situ, and polymer electrolytes that have been mixed with a catalyst paste. As shown in the figure, a catalyst exists on the surface and/or in a pore of a carbon carrier. In addition, polymer electrolytes that have been polymerized in situ are uniformly and thinly distributed on the surface and in a pore of a carbon carrier. Further, the surfaces of polymer electrolytes that have been polymerized in situ are partially coated with polymer electrolytes mixed with a catalyst paste.

A three-phase interface where reaction gas, catalysts, and electrolytes meet is sufficiently secured on a carbon carrier with the use of polymer electrolytes that have been polymerized in situ so that catalyst efficiency can be improved. Moreover, the use of a relatively thick polymer electrolyte layer mixed with a catalyst paste results in the improved conductivity between carbon carriers. Thus, catalyst efficiency can be further improved.

The term “living polymerization” in the present invention indicates polymerization whereby polymer ends continuously remain active or pseudo-living polymerization whereby inactive polymer ends and active polymer ends are in equilibrium. The definition used in the present invention encompasses both forms of polymerization. Known examples of living polymerization include living radical polymerization and living anion polymerization. In view of operationality upon polymerization, living radical polymerization is preferable.

Living radical polymerization is a form of radical polymerization, during which polymer ends remain active without being deactivated. Recently, many research groups have actively studied living radical polymerization. Examples of living radical polymerization that have been studied include living radical polymerization using a chain transfer agent such as polysulfide, living radical polymerization using a radical trapping agent such as a cobalt porphyrin complex and a nitroxide compound, and atom transfer radical polymerization (ATRP) using organic halide as an initiator and a transition metal complex as a catalyst. In accordance with the present invention, any of the above methods can be used without particular limitation. Note that a living radical polymerization method wherein a transition metal complex is used as a catalyst and an organic halogen compound comprising one or more halogen atoms is used as a polymerization initiator is recommended.

In accordance with the above living radical polymerization methods, in general, radical polymerization takes place, during which the polymerization rate is significantly high and a termination reaction involving, for example, coupling between radicals is likely to occur. However, polymerization proceeds with the use of living polymers. As a result, polymers having molecular weights within a limited molecular distribution range (approximately Mw/Mn=1.1 to 1.5) can be obtained. In addition, molecular weight can be freely controlled based on the ratio of the amount of monomer to be fed to the amount of initiator to be fed.

Hereafter, preferred embodiments of the fuel cell electrode of the present invention and a polymer electrolyte fuel cell having the same are described in greater detail.

The electrode of a polymer electrolyte fuel cell of the present invention comprises a catalyst layer. Preferably, it comprises a catalyst layer and a gas diffusion layer disposed adjacent to the catalyst layer. The gas diffusion layer is made of a porous material with electrical conductivity (such as carbon cloth or carbon paper, for example).

An example of a catalyst-supporting carbon particle that can be used is a carbon black particle. In addition, platinum metals such as platinum and palladium can be used for catalyst particles.

The effects of the present invention can be exerted particularly when the specific surface area of a carbon carrier exceeds 200 m²/g. Specifically, such carbon carrier having a wide specific surface area has a number of fine pores of nano-order sizes on the surface thereof so as to be excellent in terms of gas diffusivity. On the other hand, catalyst particles that exist in fine pores of nano-order sizes do not come into contact with polymer electrolytes, so that such catalyst particles do not contribute to reactions. Regarding this point, in accordance with the present invention, catalyst particles dispersed in polymer electrolytes come into contact with the catalyst particles even in fine pores of nano-order sizes. Thus, catalyst particles can be effectively used. Therefore, in accordance with the present invention, gas diffusivity can be improved while reaction efficiency is maintained.

### EXAMPLES

Hereafter, the fuel cell catalytic electrode and the polymer electrolyte fuel cell of the present invention will be described in greater detail with reference to the following examples.

[Production of a Catalyst-Supporting Carrier Comprising a Catalyst-Supporting Carbon Particle and Polymer Electrolytes that have been Polymerized In Situ]

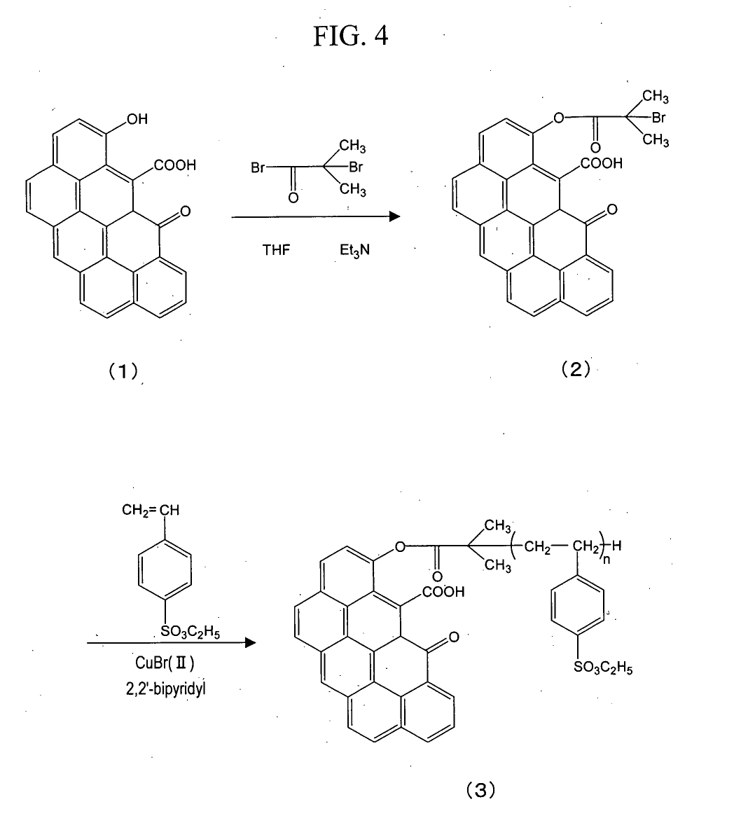

FIG. 4 shows reaction schemes of a catalyst-supporting carrier comprising a catalyst-supporting carbon particle and polymer electrolytes that have been polymerized in situ, which is used in the following examples.

First, functional groups that serve as an initiator for living radical polymerization were introduced into a platinum-supporting carbon particle. VULCANXC72 (carbon carrier) as a carbon catalyst was allowed to support platinum (40 wt % Pt) thereon. A carbon carrier (1) has a condensed ring system comprising hydroxyl groups, carboxyl groups, carbonyl groups, and the like. Hydroxyl groups in the system undergo reaction with an initiator for living radical polymerization. Originally, a carbon catalyst has hydroxyl groups. In addition, a carbon catalyst may be subjected to nitric acid treatment so as to adjust the number of hydroxyl groups. In THF, 2-bromoisobutyric acid bromide was allowed to react with phenolic hydroxyl groups of a carbon particle in the presence of a base (triethylamine) so that functional a groups serving as an initiator upon living radical polymerization were introduced into a carbon particle (2).

Then, polymers having a sulfonic acid group as a side chain were grafted to platinum-supporting carbon particles. Platinum-supporting carbon particles (2) obtained via the above reaction, into which a functional group serving as an initiation point for living radical polymerization had been introduced, were placed in a round bottom flask. Deoxygenation was carried out by introducing argon gas into the flask. Then, styrenesulfonic acid ethyl (ETSS, Tosoh) was slowly poured thereinto. Further, deoxygenation was continued. Thereafter, a transition metal compound serving as a catalyst was added thereto with its ligands according to need. The resultant was sufficiently agitated. Then, living radical polymerization was initiated using a solvent, the temperature of which does not increase during polymerization, so that platinum-supporting carbon particles obtained by grafting polymers having an ethylsulfonic acid group as a side chain were obtained (3). Herein, “n,” which represents the polymerization degree of styrenesulfonic acid ethyl as a repeat unit, is freely determined based on the amount of styrenesulfonic acid ethyl to be fed. The value of “n” is approximately 5 to 100 and preferably approximately 10 to 30, but it is not particularly limited thereto.

Sodium iodide was added to a dispersion solution of the platinum-supporting carbon particles obtained by grafting polymers having an ethylsulfonic acid group as a side chain. The ethylsulfonic acid group was subjected to hydrolysis and protonation so as to obtain sodium sulfonate. Sodium was substituted with hydrogen using sulfuric acid so that a sulfonic acid group was obtained. The resulting catalyst-supporting carbon particles were dehydrated and dispersed in water. Thereafter, the thus obtained solution was diluted 10-fold with hexane. The resulting dispersion solution was filtered and dehydrated such that fuel cell catalyst powders were obtained.

### Example

1. The catalyst powder obtained above was mixed with a mixture solution containing cyclohexanol, water, and Nafion. Then, mixture solutions (catalyst paste) were prepared, which contained 10%, 60%, 80%, and 100% Nafion by weight relative to the weight of carbon carriers, respectively.
2. The mixture solutions (catalyst paste) obtained in 1. above were added dropwise to Teflon (trade name). Then, the mixture solutions were thinly spread with a doctor blade and the like.
3. The resultants obtained in 2. above were placed in a vacuum dryer so that a solvent was removed from the resultant. Thus, thin films (catalyst layers) were produced.

### Comparative Example

A mixture solution (catalyst paste) was prepared in a manner described in the Example except that Nafion was not used. Thus, a thin film (catalyst layer) was produced.

### [Performance Evaluation]

The synthesized thin films (catalyst layers) were each joined to a fuel cell electrolyte membrane so as to produce MEAs. The obtained MEAs were subjected to measurement of cyclic voltammetry (CV). Then, performance in terms of effective use of platinum was examined based on peaks upon hydrogen oxidizing reaction.

In addition, the MEAs were used for fuel cell power generation experiments. Then, voltages upon power generation at 1 A/cm² were measured based on a current density-voltage curve.

The results are shown in table 1 and FIG. 4.

TABLE 1

| Amount of | Hydrogenation peak | Voltage upon power |
|---|---|---|
| Nafion | upon CV | generation at 1 A/cm² |
| 0 | 11.9 | 1.0 |
| 10 | 12.8 | 1.31 |
| 60 | 18.0 | 1.38 |
| 80 | 25.4 | 0.86 |
| 100 | 35.5 | 0.78 |

The results shown in table 1 revealed that, in each case of the fuel cell electrodes that were produced in accordance with the present invention, a hydrogenation peak upon CV was significantly improved as the percentage by weight of Nafion increased, compared with the case of a fuel cell electrode obtained without the mixing of perfluorocarbon polymers having sulfonic acid groups with a catalyst paste (weigh of Nafion: 0%). Thus, it is understood that the effective utilization ratio of a precious metal catalyst such as platinum supported on a carrier was significantly improved. It is thought that this is because electroconductivity was improved when the surface of polymer electrolytes that had been polymerized in situ were partially coated with polymer electrolytes mixed with a catalyst paste, compared with a case in which polymer electrolytes that had been polymerized in situ were uniformly and thinly distributed on the surface and pores of a carbon carrier.

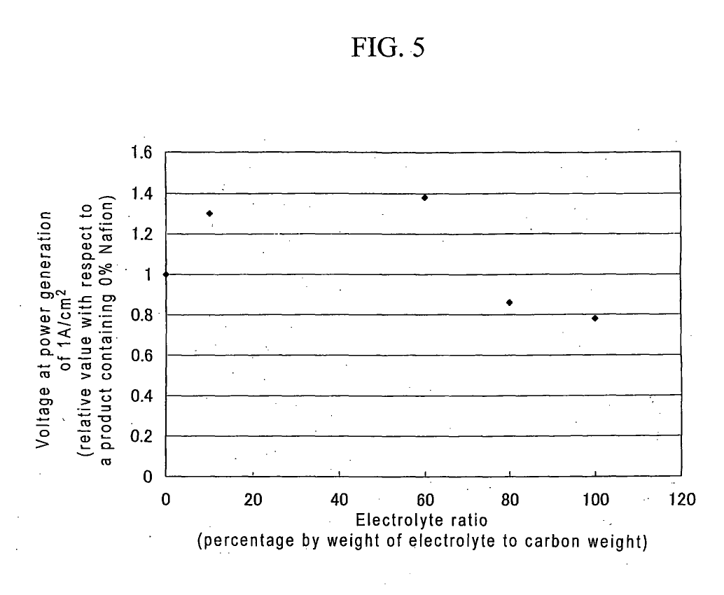

Based on the results shown in table 1 and FIG. 5, it is understood that power generation efficiency improves when the weight of Nafion to be mixed with a catalyst paste falls within the optimum range. Preferably, the weight of Nafion accounts for 5% to 70% of the weight of carbon carriers. As above, it has been demonstrated that sufficient MEA performance can be exerted with the use of the fuel cell electrode of the present invention.

### INDUSTRIAL APPLICABILITY

As described above, in accordance with the present invention, the sufficient presence of a three-phase interface where reaction gas, catalysts, and electrolytes meet can be secured in a carbon carrier, resulting in significantly improved efficiency of catalysts used in a fuel cell. Such efficient progress of electrode reaction results in improved power generation efficiency of fuel cells. Thus, the present invention contributes to the practical application and widespread use of fuel cells

1. A method for producing a fuel cell electrode, comprising the steps of:
allowing a carbon carrier having pores to support a catalyst;
introducing a functional group serving as a polymerization initiator onto the surface and/or into the pores of, the carbon carrier having pores;
introducing monomer electrolytes or monomer electrolyte precursors so as to polymerize the monomer electrolytes or the monomer electrolyte precursors using the polymerization initiator as an initiation point;
allowing polymers on the catalyst-supporting carrier to be protonated; dehydrating protonated products and dispersing them in water;
allowing the dispersion products to be subjected to filter treatment; and
preparing a catalyst paste using the obtained catalyst powders and forming the catalyst paste into a given form so as to produce a catalyst layer;
and characterized in that perfluorocarbon polymers having sulfonic acid groups are mixed with the catalyst paste when a catalyst layer is produced using the obtained catalyst powder.

2. The method for producing a fuel cell electrode according to claim 1, characterized in that the amount of the perfluorocarbon polymers (which have sulfonic acid groups) mixed accounts for 5% to 7.0% of the weight of carbon carriers.

3. The method for producing a fuel cell electrode according to claim 1 or claim 2, characterized in that the polymerization initiator is a living radical polymerization initiator or a living anion polymerization initiator.

4. The method for producing a fuel cell electrode according to claim 3, characterized in that the living radical polymerization initiator is 2-bromoisobutyric acid bromide.

5. The method for producing a fuel cell electrode according to any one of claims 1 to 4, characterized in that a polymer is subjected to hydrolysis or ion exchange groups are introduced into the polymer after the polymer is obtained by polymerization of the monomer electrolyte precursor.

6. The method for producing a fuel cell electrode according to any one of claims 1 to 5, characterized in that the monomer electrolyte precursor is styrenesulfonic acid ethyl.

7. A polymer electrolyte fuel cell comprising an anode, a cathode, and a polymer electrolyte membrane disposed between the anode and the cathode, comprising the fuel cell electrode produced by the method of any one of claims 1 to 6 as the anode and/or cathode.
